(19) United States
(12) Patent Application Publication
(10) Pub. No.: US 2018/0009335 A1
(43) Pub. Date: Jan. 11, 2018

(54) DEVICE CAPABLE OF DETECTING A BEARING FORCE

(71) Applicant: Crouzet Automatismes, Valence (FR)

(72) Inventors: Dorian Laugt, Romans-Sur-Isere (FR); Ludovic Niguet, Toulaud (FR); Patrick Duvallet, Guyancourt (FR)

(21) Appl. No.: 15/636,107

(22) Filed: Jun. 28, 2017

(30) Foreign Application Priority Data
Jul. 6, 2016 (FR) 1656499

(51) Int. Cl. B60N 2/00; B60N 2/64; B60N 2/44; G01L 1/04; B60R 21/015

(52) U.S. Cl. CPC B60N 2/002; G01L 1/04; B60R 21/0152; B60N 2/44; B60N 2/64

(57) ABSTRACT

An illustrative device capable of detecting a bearing force includes a support rigid by tension and at least one plate that is elastically deformable by the bearing force from a bent conformation in which the plate exhibits a convex bearing face on which the bearing force to be detected is directly exerted and to a more flattened conformation in which the convex bearing face is more flattened. The illustrative device further includes a spring capable of permanently straining the plate to its bent conformation, a guiding mechanism mounted on the support and capable of guiding the free distal end of the plate in translation along a translation axis at right angles to the direction of indentation, and a sensor capable of detecting a displacement of the free distal end along the translation axis to detect the bearing force.

### CROSS REFERENCE TO RELATED APPLICATION(S)

This application claims priority to French Patent Application No. FR1656499 entitled “DISPOTIF APTE A DETECTER UNE FORCE D'APPUI” and filed on Jul., 6, 2016, which is incorporated by reference in its entirety.

### FIELD OF THE INVENTION

Aspects of this disclosure relates generally to a device capable of detecting a bearing force. More specifically, aspects of the disclosure relates to a device capable of detecting a bearing force incorporated into a bottom rest of a seat and a seat incorporating this device.

### BACKGROUND OF THE INVENTION

In this description, “device capable of detecting a bearing force” and “device for detecting a bearing force” should be understood to mean both: a device solely capable of delivering binary information, namely, alternately, the presence and the absence of the bearing force, or a device capable also of measuring the amplitude of the bearing force and/or of measuring the displacement provoked by the bearing force.

Such detection devices, for example, may be used to detect the presence of a passenger seated in a seat of a motor vehicle. An example of such a detection device is described in the application U.S. Pat. No. 7,049,974B2. As this patent indicates, it may be desirable to reduce the bulk of such detection devices. It is also desirable to simplify to the maximum the architecture thereof to simplify the manufacture thereof and the assembly thereof in the final application and therefore reduce the costs thereof.

Now, as illustrated by the embodiment of FIG. 2 of U.S. Pat. No. 7,049,974B2, the known detection devices comprise numerous parts fitted into one another which are displaced relative to one another in order to detect the bearing force. The prior art is also known from: WO99/41565A1, DE102013213672A1, and WO02/18892A2.

### SUMMARY OF THE INVENTION

Aspects of the disclosure aims to propose such a detection device that is easier to manufacture. Its subject is therefore a device capable of detecting a bearing force according to claim 1. An illustrative device claimed may be particularly simple to manufacture because the plate simultaneously fulfils the following functions:
the function of the bearing face on which the bearing force to be detected is directly exerted, and
the connecting rod function which transforms a movement parallel to the direction of indentation into a movement at right angles to this direction of indentation.

Furthermore, by transforming the movement parallel to the direction of indentation into a movement at right angles to this direction, it is possible to reduce the height of the device, that is to say, the bulk of the device in the direction of indentation. In effect, for some applications, such as the detection of a passenger seated in the seat for example, the height of the device must be limited. With the device claimed, the sensor which detects the displacement of the free distal end of the plate can be placed alongside the plate and not under the mobile part displaced by the bearing force as in the conventional devices. That therefore makes it possible, if so desired, to reduce the height of the device.

The illustrative embodiments of this detection device can comprise one or more of the features of the dependent claims.

These embodiments of the detection device can further offer one or more of the following advantages:
By using a spring plate, it is possible to fulfil both the functions of the plate and of the spring using a single part. That therefore simplifies the production of the device since the same plate spring fulfils the functions of both the plate and the spring.
By placing the sensor alongside the distal end which is displaced, it is possible to reduce the height of the device. In effect, the sensor no longer has to be placed under the mobile part which is displaced in the direction of indentation. On the contrary, here, the sensor is placed alongside, in a direction at right angles to the direction of indentation of this mobile part, namely alongside the plate. That therefore makes it possible to reduce the overall height of the detection device.
By using a plate whose ratio f/L is less than 0.5, it is possible to further reduce the bulk of the device. In effect, because of its initial bent conformation, the travel of the distal end of the plate is less than the travel of the plate in the direction of indentation. The sensor should therefore detect a displacement of smaller amplitude than if it had to detect the travel of the plate in the direction of indentation. That makes it possible to use a sensor of smaller size and therefore reduce the bulk of the device. Furthermore, the precise setting of this ratio f/L makes it possible to adjust the travel of the distal end to the amplitude of the displacements that the sensor can detect.
The fact that the rigid support is planar also makes it possible to further reduce the height of the device.
The use of a guiding mechanism produced by the simple co-operation of a bearing plane and an abutment makes it possible to simplify the device.
The fact that the shortest distance between the proximal and distal ends is greater than 7 cm increases the sensitivity of the device in the direction of translation of the free distal end. This facilitates the use of this device in the bottom rest of a seat to detect the presence of a passenger seated on this seat.

Also subject of the disclosure are a bottom rest of a seat and a seat comprising the device claimed.

The placement of the device for detecting the bearing force inside the foam block makes it possible to avoid disturbing the comfort of the occupant seated on this bottom rest. That also avoids disturbing the layout and the operation of other appliances incorporated in the bottom rest such as, for example, heating plies, ventilation or an occupant massage mechanism. Finally, that limits the constraints imposed on the design of the bottom rest. In particular, the layout of the detection device inside the foam block makes it possible to produce trims and stitchings of the bottom rest at any point.

The placement of the detection device in one of the rear quarters of the bottom rest as claimed makes it possible to more reliably detect an occupant seated on the seat or a child seated in a child seat. In effect, by placing the detection device in this way, the number of accidental detections provoked either by an inert object of any form or by a child seated in a seat fixed to this bottom rest by a fixing mechanism according to the ISOFIX standard is limited.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 is a schematic illustration in vertical cross section of motor vehicle comprising a seat;

FIG. 2 is an illustration, in plan view, of the bottom rest of the rear seat of the vehicle of FIG. 1;

FIG. 3 is a partial illustration, in vertical cross section, of the bottom rest of FIG. 2;

FIG. 4 is a perspective illustration of a detection device housed in the bottom rest of FIG. 3;

FIG. 5 is an illustration, in side view, of the device of FIG. 4;

FIG. 6 is an illustration, in plan view, of the device of FIG. 4;

FIGS. 7 to 12 are perspective illustrations of other possible embodiments of the detection device of FIG. 4;

FIG. 13 is a schematic illustration, in vertical cross section, of another possible positioning of the detection device inside a bottom rest;

FIG. 14 is also a perspective schematic illustration of another possible positioning of the detection device of FIG. 4 in the bottom rest of a seat.

In these figures, the same references are used to designate the same elements. Hereinafter in this description, the features and functions that are well known to those skilled in the art are not described in detail.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

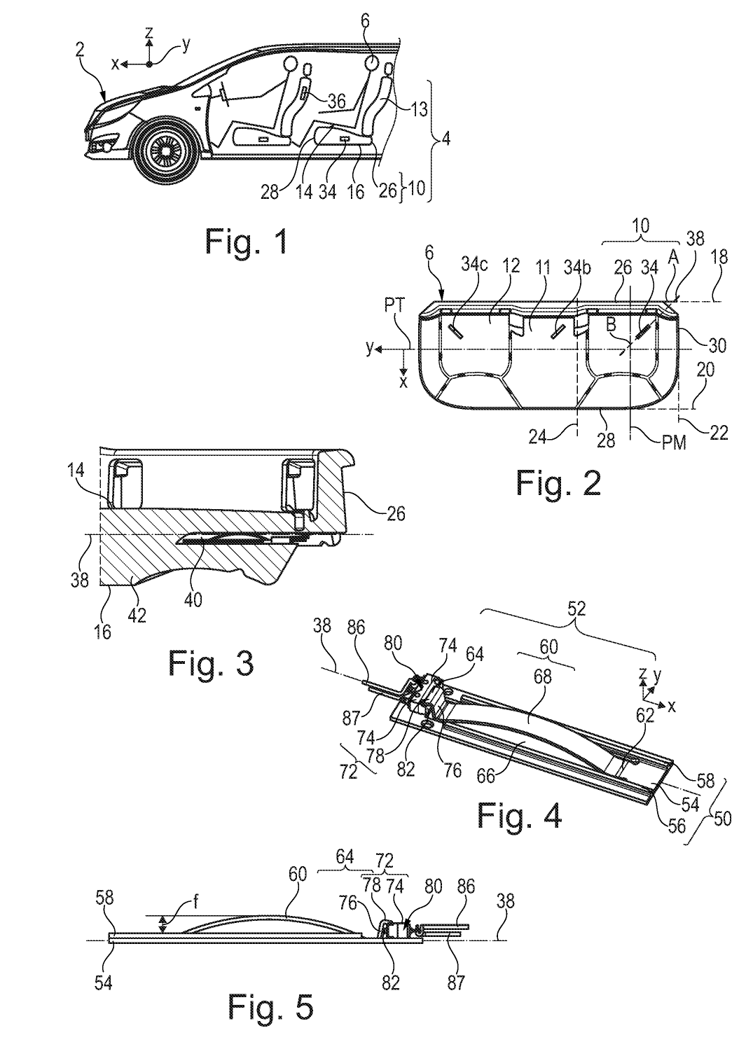

FIG. 1 represents a motor vehicle 2 equipped with a seat 4 on which a passenger 6 is seated. In FIG. 1, the passenger 6 is a rear passenger of the vehicle 2 and the seat 4 is a rear bench seat of this vehicle 2. However, everything that is described hereinbelow applies to any other seat of a motor vehicle, and, in particular, to the front seats of the vehicle 2.

The seat 4 will now be described in more detail with reference to FIGS. 1 and 2. The seat 4 comprises three bottom rests 10, 11 and 12 (FIG. 2) arranged alongside one another in a horizontal direction Y of an orthogonal reference frame XYZ. The seat 4 also comprises a backrest 13 (FIG. 1). In these FIGS. 1 and 2, as in the subsequent figures, the horizontal is marked by the directions X and Y of the reference frame XYZ. The direction X is here parallel to the longitudinal direction of the vehicle 2, that is to say the direction in which the vehicle 2 advances in a straight line. The direction Z is the vertical direction. Hereinbelow, the terms such as “top”, “bottom”, “up”, “down”, “above” and “below” are defined in relation to the direction Z.

Here, “bottom rest” is used to denote the part of the seat 4 intended to receive the posterior of a single passenger. Hereinbelow, only the bottom rest 10 is described in detail in the knowledge that the teaching given in this particular case applies equally to any other bottom rest of this seat.

The bottom rest 10 comprises a top face 14 (FIG. 1) on which the posterior of the passenger 6 directly rests and a bottom face 16 situated on the opposite side. The faces 14 and 16 extend primarily parallel to the horizontal plane XY.

The orthogonal projection of the bottom rest 10 in the horizontal plane XY is situated inside a rectangle. This rectangle is the rectangle of smallest surface area which entirely contains this orthogonal projection. This rectangle has:
a rear side 18,
a front side 20, and
two lateral sides 22 and 24 (FIG. 2).

The sides 18 and 20 are parallel to the direction Y. They pass, respectively, through a rear edge 26 and a front edge 28 of the bottom rest 10. The rear edge 26 is the one closest to the back rest 13. This edge is generally linked to this back rest 13. The front edge 28 is situated on the side opposite the edge 26 in the direction X. The sides 18 and 20 are symmetrical to one another in relation to a transverse vertical plane PT.

The lateral sides 22 and 24 are situated on either side of the part where the passenger 6 sits. They are symmetrical to one another in relation to a median vertical plane PM of the bottom rest 10. In the case represented here where the bottom rest 10 is the rightmost bottom rest of the seat 4, the lateral side 22 is situated at a right lateral edge 30 of the bottom rest 10.

In the case of a bench seat, the lateral side 24 does not correspond to an edge of the bottom rest. On the contrary, the lateral side 24 coincides with the right lateral side of the central bottom rest 11 of the seat 4. Thus, in the case where the bottom rest considered is the central bottom rest 11 of the bench seat, neither of the lateral sides corresponds to an edge of the seat 4.

The planes PT and PM intersect along an axis which passes through the centre of the rectangle. They also cut this rectangle which surrounds the bottom rest 10 into four identical portions.

It is useful to detect the presence of a passenger seated on the bottom rest 10 to control, based on this information, one or more electronic appliances of the vehicle 2. To this end, the bottom rest 10 comprises a device 34 for detecting the bearing force exerted by the weight of the passenger 6 when he or she is seated on the bottom rest 10. The bearing force is exerted primarily vertically from top to bottom.

As an illustration, the device 34 is used here to control the triggering of the inflation of an airbag 36 (FIG. 1), also sometimes called “inflatable cushion”. For example, the airbag 36 is housed in a lateral wall or in a dashboard of the vehicle 2. Thus, when the device 34 detects the absence of a sufficient bearing force, the triggering of the airbag 36 is for example inhibited.

Typically, so as not to accidentally inhibit the triggering of the airbag 36 or, on the contrary, not to accidentally authorize the triggering of this airbag 36, it is necessary for the device 34 to observe the following constraints:
detect the presence of a passenger weighing more than 29 kg seated on the bottom rest 10,
detect the presence of a child seated on a child seat which itself rests on the bottom rest 10 when the weight of the child seat and the child is greater than 15 kg,
not detect an object, whose weight is less than 5 kg, placed on the bottom rest 10, and
not detect a child seated in a child seat fixed onto the bottom rest 10 by an anchoring mechanism conforming to the ISOFIX standard (standard ISO 13216-1: 1999) or conforming to the American LATCH standard (Lower Anchors and Tethers for Children).

For that, the device 34 is a device comprising a slender face 68 (FIG. 4) sensitive to the bearing force. This face 68 extends primarily along a horizontal axis 38.

To observe the constraints stated above, the device 34 is arranged in one of the two rear quarters of the rectangle delimited by the sides 18, 20, 22 and 24. Here, the device 34 is arranged inside the right rear quarter. More specifically, the device 34 is arranged inside the bottom rest 10 in such a way that the orthogonal projection of the axis 38 in the horizontal plane XY passes through points A and B. The point A is situated at a distance d_{A} from the vertex of the rectangle situated at the intersection of the sides 18 and 22. The point B is situated at a distance d_{B} from the center of the rectangle. Here, the distances d_{A} and d_{B} are both less than 0.2 dₐᵣ or 0.1 dₐᵣ, where the distance dₐᵣ is the length of the side 18 of the rectangle. Typically, the distance dₐᵣ lies between 45 and 60 cm.

Here, the point B is situated in the plane PM. For example, it is situated between 1.5 cm and 5 cm forward of the projection of the point H on the plane XY. The position of the point H is known to those skilled in the art. It will simply be recalled here that the point H is the point situated at the intersection of the plane PM, of the plane containing the spinal column of the passenger 6 and the plane containing the femurs of the passenger 6. The plane containing the spinal column is a vertical plane, parallel to the direction X, and which contains most of the spinal column of the passenger 6 when he or she is seated on the bottom rest 10 and resting on the backrest 13. The plane containing the femurs is a horizontal plane, parallel to the plane XY, and passing through the axes of the two femurs of the passenger 6 in the same position as that defined for the plane of the spinal column.

Here, the device 34 is arranged at a distance d_{B}34 from the point B. The distance d_{B}34 is greater than 2 or 3 cm and generally less than 10 cm or 6 cm. For example, the distance d_{B}34 is equal to 4.5 cm.

In FIG. 2, detection devices 34b and 34c, housed inside, respectively, the bottom rests 11 and 12 can be seen. Their positioning inside their respective bottom rest is deduced from the preceding explanations.

FIG. 3 represents a partial view in vertical cross section of the bottom rest 10 along the axis 38. In this exemplary embodiment, the bottom rest 10 comprises a horizontal housing 40 which extends primarily along the axis 38. The device 34 is housed inside this housing 40. Here, the housing 40 is hollowed out inside a foam block 42 of the bottom rest 10. For example, this housing is hollowed out from the rear edge 26 of this bottom rest 10. Typically, the foam block 42 has a Shore hardness on the scale A less than 50 and, preferably, less than 30. Generally, the Shore hardness on the scale A of the block 42 is greater than or equal to 10 or 20. Hereinbelow, “flexible materials” will denote any materials whose hardness lies within the limits defined for the foam block 42.

The edges and the top face of the block 42 are generally covered with a covering such as genuine or artificial leather or even a fabric.

The housing 40 is situated at least 1 cm or 2 cm under the top face 14. Here, it is situated between 2.5 cm and 4 cm under this face 14. Because of that, the presence of the device 34 cannot be felt by the passenger 6 when he or she is seated on the bottom rest 10. The housing 40 is situated at least 1 cm or 2 cm above the bottom face 16 of the bottom rest 10. By virtue of that, the housing 40 hollowed out in the block 42 is sufficient in itself to keep the device 34 in place. In particular, it is not necessary to also fix the device 34 to a reinforcement of the seat 4 or onto a suspension ply. That therefore simplifies the installation of the device 34 in the bottom rest 10.

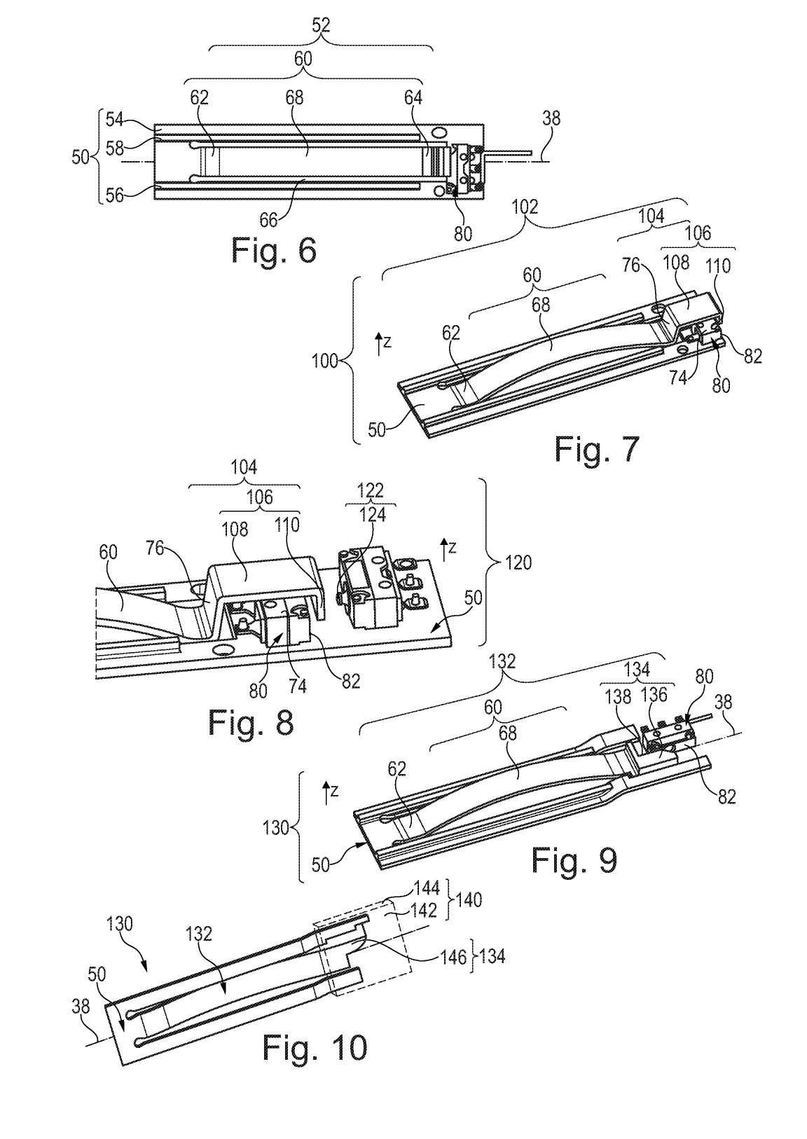

The device 34 will now be described in more detail with reference to FIGS. 4 to 6. The device 34 comprises:
a rigid support 50 which extends primarily in a horizontal plane, and
the plate spring 52.

The support 50 comprises a horizontal planar plate 54 rigid by tension. “Rigid by tension” or simply “rigid” describes a support whose rigidity by tension is such that, in response to the maximum elongation force exerted by the plate of the plate spring 52 on this support, the elongation of the support in the direction of this course remains less than Ls/10 or Ls/100 or Ls/1000, where Ls is the length of the support in this direction when the plate of the plate spring exerts no elongation force. Here, the support 50 is also flexurally rigid, that is say more flexurally rigid, and preferably two or ten times more flexurally rigid, than the plate spring 52. To this end, here, the horizontal section of the plate 54 is rectangular. The longest sides of the plate 54 extend parallel to the axis 38. The thickness of the plate 54 is for example greater than or equal to 0.7 mm or 1 mm. This plate is produced in a hard material such as a metal like a steel or a hard plastic. “Hard material” in this description describes a material whose Young's modulus at 25° C. is greater than 1 GPa and, preferably, greater than 10 GPa or 50 GPa or 100 GPa.

In this exemplary embodiment, to further limit the flexural deformation of the plate 54 when it is subjected to a vertical bearing force, rectilinear ribs 56 and 58 parallel to the axis 38 are produced on one of the horizontal faces of this plate 54. The thickness of these ribs 56, 58 is for example greater than or equal to the thickness of the plate 54. These ribs 56 and 58 extend over at least 50% and, preferably, at least 70% or 80%, of the length of the plate 54 in a direction parallel to the axis 38. Here, the length of the plate 54 in a direction parallel to the axis 38 is greater than or equal to 8 cm or 10 cm and, generally, less than 20 cm or 15 cm. The width of the plate 54 in a horizontal direction at right angles to the axis 38 is generally less than 3 cm or 5 cm.

In this embodiment, the spring 52 comprises a single plate 60 which extends primarily along the axis 38, from a proximal end 62 to a distal end 64. The proximal end 62 is mounted, with no degree of freedom, on the support 50. Conversely, the end 64 displaces relative to the support 50. Here, the plate 60 forms only a single continuous block of material with the support 50. For example, to this end, the plate 60 and the support 50 are manufactured at the same time by 3D printing. Here, the plate 54 comprises a through hole 66 which extends along the axis 38 under the plate 60 and whose width is strictly greater than the width of the plate 60.

Between the ends 62, 64, the plate 60 is bent and exhibits a convex bearing face 68 on which the bearing force to be detected is directly exerted. To this end, the width of the face 68 is greater than 0.8 cm or 1 cm and generally less than or equal to 3 cm. For example, the face 68 is symmetrical to a vertical plane at right angles to the axis 38 and situated mid-way between the ends 62 and 64.

To exhibit an increased sensitivity in the direction of the axis 38, the length L of the plate 60 between its ends 62 and 64 is greater than 6 cm or 8 cm, that is to say typically at least two or three times greater than the width of this same plate. The length L is also generally less than 16 cm or 12 cm.

In this embodiment, it is the foam of the block 42 which comes to bear directly and conformationally on one side on the face 68 and, on the opposite side, on a bottom face of the plate 54.

The spring 52 is deformable, by elastic deformation of the plate 60, between a bent conformation represented in FIGS. 4 and 5 and a more flattened conformation. The bent conformation corresponds to the initial conformation of the plate 60, that is to say its conformation in the absence of bearing force on the face 14. In the bent conformation, the plate 60 exhibits a bow f (e.g., FIG. 5). The bow f is defined as being the distance between the point of the plate 60 of highest altitude measured in relation to the horizontal plane containing the top face of the plate 54. As an illustration, the orthogonal projection of the bearing face 68 on a vertical plane parallel to the axis 38 forms a circular arc.

In the flattened conformation, the amplitude of the bow f is smaller than its amplitude in the bent conformation. For example, the amplitude of the bow f is one or two times smaller than in the bent conformation. If the bearing force is extremely significant in the more flattened conformation, the amplitude of the bow f can be zero.

The device 34 also comprises a guiding mechanism 72 for guiding the end 64 in translation along the axis 38. More specifically, this mechanism 72 prevents the vertical bearing force which is exerted directly on the face 68 of the plate 60 from pivoting this end 64 about a rotation axis that is horizontal and at right angles to the axis 38 and passing through the end 62. This mechanism 72 allows the end 64 to be displaced freely, in relation to the support 50, by sliding along the axis 38 in one direction and, alternately, in the opposite direction. In these conditions, because of the mechanism 72, the plate 60 converts, using a single part, the vertical bearing force into a translational horizontal displacement of the end 64 along the axis 38. The translation axis of the end 64 therefore coincides with the axis 38.

The maximum travel of the end 64 along the axis 38 between the bent and more flattened conformations is hereinbelow denoted ΔL. Typically, the travel ΔL is greater than 0.5 mm or 1 mm or 2 mm. To obtain a travel ΔL smaller than the variation Δf of the amplitude of the bow f between its bent and more flattened conformations, in the bent position, the amplitude of the bow f is less than or equal to L/2 or L/3 and, preferably, less than or equal to L/5 or L/8. By virtue of that, a displacement of the end 64 can be detected over a shorter travel and therefore using a smaller sensor.

Here, the mechanism 72 comprises a horizontal bearing plane 74 and a bearing abutment 78 sliding on this plane 74. The plane 74 extends along the axis 38 over a length strictly greater than the travel ΔL so that, whatever the conformation of the spring 52, the abutment 78 can always rest on the bearing plane 74.

Here, the plane 74 is formed by the planar top wall of a rigid casing of a sensor 80. The casing of the sensor 80 is essentially parallelpipedal. The bottom wall of this casing is mounted, with no degree of freedom, on the top face of the plate 54.

To form the abutment 78, the end 64 comprises:
a flat 76 which rises vertical to pass above the level of the plane 74, immediately followed by
a flat which redescends for its end to come to rest, slidingly bearing, on the plane 74 even in the bent conformation.

This flat which redescends forms the abutment 78. Thus, in this embodiment, the end 64 is conformed to form the abutment 78.

Finally, the device 34 comprises the sensor 80 which detects whether the displacement of the end 64 crosses a predetermined threshold S1. To limit the height of the device 34, the sensor 80 is mounted, with no degree of freedom, on the top face of the support 50. More specifically, the sensor 80 is situated alongside the end 64 in the extension of the plate 60 and along the axis 38. In this embodiment, the sensor 80 is a proximity detector comprising a sensitive face 82. Here, the sensor 80 detects the proximity of the flat 76. To this end, the sensitive face 82 is vertical and facing this flat 76.

Various technologies are possible for producing the sensitive face 82 which detects the proximity of the flat 76 if the latter is displaced by a distance greater than the threshold S1. For example, in a particularly simple and energy-efficient embodiment, the sensor 80 is a switch and the face 82 is one end of a push button of this switch. This sensor switches over from an off state to an on state as soon as the push button is depressed. In the bent conformation, the flat 76 and face 82 are separated by a distance equal to the threshold S1 and the sensor 80 is in its off state. For example, in the off state, the sensor 80 electrically isolates the wires 86 and 87. When the bearing force deforms the plate 60, the flat 76 advances along the axis 38 and ends up coming into contact with the sensitive face 82 when it has covered the distance S1. In response, the sensor 80 switches over to its on state and electrically connects the wires 86 and 87 together. Such a change in resistivity indicates to the embedded electronics of the vehicle 2 that the passenger 6 is seated on the bottom rest 10. In response, the embedded electronics allow the triggering of the airbag 36 in the case of an accident. When the passenger 6 leaves the seat 4, the bearing force disappears. In response, the plate 60 automatically reverts to its bent conformation and the flat 76 once again moves away from the face 82. The sensor 80 reverts automatically to its off state. The device 34 has therefore reverted to its initial position.

It will be noted that the threshold S1 can easily be adjusted by various means, including notably:
by adjusting the distance which separates the sensitive face 82 from the flat 76 in the bent confirmation, and/or
by adjusting the stiffness of the plate 60, and/or
by adjusting the length L and the bow f of the plate 60.

FIG. 7 represents a detection device 100 that can be used in place of the device 34. The device 100 is identical to the device 34 except that the plate spring 52 is replaced by a plate spring 102. The spring 102 is identical to the spring 52 except that the end 64 is replaced by an end 104. The end 104 is identical to the end 64 except that the flat 76 is extended by a bracket 106 which comprises a horizontal flat 108 which passes over the plane 74 then a vertical flat 110 which redescends vertically after the sensor 80. In this embodiment, the sensitive face 82 of the sensor 80 is turned to the side opposite the end 62 to be located facing the vertical flat 110. Furthermore, the sensor 80 is mounted on the support 50 so that, in the bent conformation, the flat 110 is bearing on the sensitive face 82. Thus, in this embodiment, in the bent conformation, the sensor 80 is in its on state.

The operation of the device 100 is the same as that of the device 34 except that the sensor 80 is in its on state in the bent conformation and switches over to its off state in response to a bearing force sufficient to move the flat 110 away from the sensitive face 82. Furthermore, in this embodiment, the abutment of the guiding mechanism is formed by the flat 108 slidingly bearing on the plane 74 and no longer by the flat 78.

FIG. 8 represents a detection device 120 that can be used in place of the device 100. The device 120 is identical to the device 100 except that it also comprises an additional sensor 122 mounted, with no degree of freedom, on the support 50. The sensor 122 is identical to the sensor 80. Its sensitive face has the reference 124. Here, the sensitive face 124 is facing the sensitive face 82 of the sensor 80. The vertical flat 110 is received between the sensitive faces 82 and 124. In the bent conformation, the sensitive face 124 is separated from the flat 110 by a non-zero distance greater than the threshold S2. This non-zero distance is chosen such that the flat 110 comes into contact with the sensitive face 124 only if the bearing force exerted on the face 68 exceeds a predetermined second threshold S2.

The operation of the device 122 is the same as that of the device 100 except that, in addition, if the bearing force exceeds the threshold S2, the sensor 122 detects the crossing of this threshold S2 and switches over from its off state to its on state. Thus, the sensor 120 is capable of detecting the crossing of the threshold S1 then of the threshold S2 by the bearing force.

FIGS. 9 and 10 represent a detection device 130 that can be used in place of the device 34. The device 130 is identical to the device 34 except that:
the plate spring 52 is replaced by a plate spring 132, and
the sensor 80 is pivoted by 90 degrees about a vertical axis such that its sensitive face 82 extends in a vertical plane parallel to the axis 38.

The spring 132 is identical to the spring 52 except that the end 64 is replaced by an end 134. The end 134 comprises an extension 136 which has a vertical wall 138 which extends along the axis 38. The vertical wall 138 extends facing the sensitive face 82 of the sensor 80. Preferably, the end of the extension 136 is beveled to depress the end of the push button which constitutes the sensitive face 82 in a direction at right angles to the vertical wall 138. Thus, in this embodiment, the extension 136 can be displaced beyond the sensor 80 without it coming into abutment on this sensor. The adjustment of the travel of the end 134 can therefore be less precise than in the case of the device 34.

In this embodiment, the bearing plane 74 is not used to guide the end 134 in translation. Instead, the guiding mechanism comprises a parallelpipedal casing 140 represented by dotted lines in FIG. 10. This casing 140 is secured to the support 50. More specifically, the casing 140 comprises a bottom planar wall 142 and a top planar wall 144 that are mechanically linked to one another by vertical lateral walls. The walls 142 and 144 pass, respectively, under and over the support 50 and the end 134. Thus, in this embodiment, the mechanism guiding the end 134 in translation comprises:
a bottom wall 142 whose top face forms the bearing plane of the guiding mechanism, and
a bottom face 146 of the end 134 which forms the abutment of this guiding mechanism. In effect, this face 146 slides over the bearing plane when the spring 132 is deformed between its bent and more flattened conformations.

In this embodiment, the sensor 80 is also housed inside the casing 140 and fixed with no degree of freedom, for example, to the wall 142 of this casing. Thus, when manufacturing the device 130, the position of the sensor 80 along the axis 38 is easily adjusted by sliding the casing 140 more or less along this axis 38. That therefore makes it possible to simply adjust the threshold S1 and therefore the sensitivity of the device 130. Then, when the casing 140 is in the desired position, it can be locked in this position for example using a spot of glue or the like.

The operation of the device 130 is deduced from the operation of the device 34.

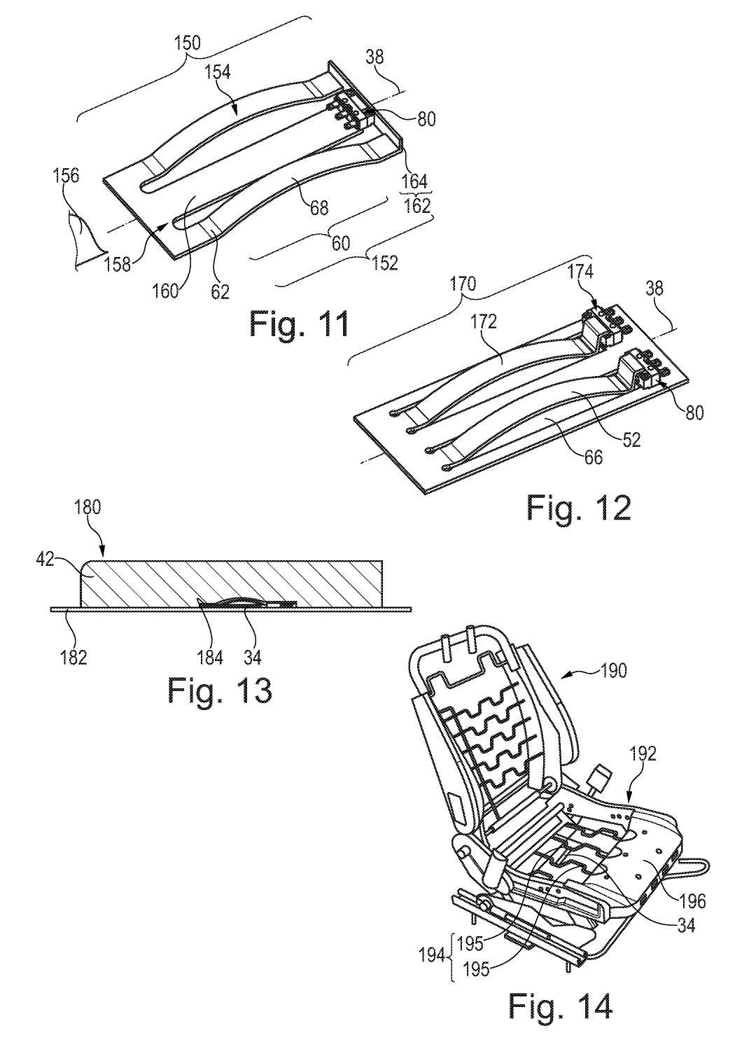

FIG. 11 represents a device 150 that can be used in place of the device 34. This device 150 is identical to the device 34 except that:
the plate spring 52 is replaced by two plate springs 152 and 154 that are symmetrical to one another in relation to a median vertical plane 156 containing the axis 38, and
the support 50 is replaced by a support 158 that is also symmetrical in relation to this plane 156.

The support 158 comprises a rigid arm 160 which extends along the axis 38 and to the end of which the sensor 80 is fixed with no degree of freedom.

The spring 152 is identical to the spring 52 except that the end 64 is replaced by an end 162. The end 162 comprises a vertical flat 164 which extends at right angles to the axis 38. This vertical flat 164 links the distal ends of the springs 152 and 154 together.

The sensitive face 82 of the sensor 80 is facing the vertical flat 164. Here, in the bent conformation, the vertical flat 164 is bearing on the sensitive face 82 such that the sensor 80 is in its on state. When a bearing force flattens at least one of the springs 152 or 154, the vertical flat 164 moves away from the sensitive face 82 and the sensor 80 switches over to its off state.

The operation of the device 150 is similar to that described for the device 100. However, the presence of two plates arranged alongside one another in a horizontal direction at right angles to the axis 38 increases the sensitivity of the device 150 in this direction.

To simplify FIG. 11, the mechanism for guiding the free distal ends of the springs 152 and 154 has not been represented. This guiding mechanism is, for example, similar to that described with reference to FIG. 10.

FIG. 12 represents a device 170 that can be used in place of the device 34. The device 170 is identical to the device 34 except that it comprises:
in addition to the spring 52, an additional plate spring 172, and
in addition to the sensor 80, an additional sensor 174.

The springs 172 and 52 are arranged symmetrically, in relation to a vertical plane containing the axis 38. Similarly, the sensors 80 and 174 are arranged symmetrically, in relation to this same vertical plane containing the axis 38.

The spring 172 operates with the sensor 174 to detect that a bearing force exceeds a predetermined threshold S2. On this point, the operation is the same as that described with the spring 52 and the sensor 80. However, here, the threshold S2 is different from the threshold S1. To this end, for example:
the bent conformation of the spring 172 is different from the bent conformation of the spring 52. For example, the bow and/or the length of the spring 172 is different from that of the spring 52, and/or
the stiffness of the spring 172 is different from that of the spring 52, and/or
the sensitivity of the sensor 174 is different from that of the sensor 80.

Thus, the device 170 makes it possible to detect the crossing of two different thresholds S1 and S2 by the bearing force.

In the embodiment of FIG. 12, the plates of the springs 52 and 172 form only a single continuous block of material with the same rigid support.

FIG. 13 represents a bottom rest 180 that can be used in place of the bottom rest 10.

The bottom rest 180 is identical to the bottom rest 10 except that the foam block 42 rests on a rigid plate 182 and the housing 40 is replaced by a housing 184. The housing 184 is identical the housing 40 except that it is situated at the interface between the foam block 42 and the rigid plate 182. In these conditions, the bottom face of the device 34 rests directly on the plate 182.

FIG. 14 represents another possible way of installing the device 34 in a seat 190. The seat 190 comprises a bottom rest 192. The bottom rest 192 comprises a foam block which rests on a suspension ply 194. In this figure, the foam block has not been represented to reveal the ply 194. Typically, the ply 194 comprises steel wires 195 stretched on a rigid frame 196 and the foam block rests on these wires 195. In this case, the device 34 is for example fixed and stretched between two wires 195 of the ply 194. Thus, the device 34 is once again, as in the embodiment of FIG. 13, housed under the foam block.

Many other embodiments are possible. For example, the support 50 is not necessarily planar. For example, to facilitate the fixing of the support inside an indentation, the latter can be dished in the same direction as the plate 60 or in the opposite direction.

In a variant, the support 50 is not flexurally rigid. For example, the support is a wire or a strip that is flexurally flexible and only rigid by tension which keeps the sensor 80 immobile in translation in relation to the end 62 along the axis 38. For example, to this end, this flexible support is fixed, on one side, to the end 62 and, on the other side, to the sensor 80. When used, this flexible support rests for example on the bottom of the housing 40. This flexible support can then be flexurally deformed in response to the bearing force. That makes it possible, for example, to make the presence of the detection device inside the bottom rest even less detectable by feel than in the case where the support is flexurally rigid.

In another variant, the support 50 is merged with the plate 182 of the bottom rest 180.

The support and the plate can be manufactured independently of one another then mounted one on top of the other by an assembly means such as a screw, glue or a spot weld.

In a variant, the ribs 56 and 58 are omitted or, on the contrary, additional ribs are added to increase the flexural rigidity of the rigid support.

In a more complex embodiment, the plate is formed by several thin plates stacked one on top of the other in the direction of indentation.

In a variant, the free end of the plate is situated in a horizontal plane situated above or below the horizontal plane in which the proximal end is situated.

The plate spring can be replaced by a flexible plate and a spring independent of the plate.

This independent spring co-operates with the plate to return it automatically to its bent conformation as soon as the bearing force disappears. For example, this independent spring is that which pushes back the push button of the sensor 80 to its protruding position. In this case, the travel of the push button is long enough for it to permanently bear mechanically on the distal end of the plate both in its bent conformation and in its more flattened conformation. As soon as the bearing force disappears, the independent spring returns the push button to its initial position which at the same time returns the plate to its bent conformation. The independent spring can also be interposed between the convex part of the plate and the support 50 so as to permanently strain the plate to its bent conformation. In the latter case, the spring is for example a piece of elastomer material. In the case where an independent spring is used, the flexible plate can be without elasticity, that is to say incapable of storing sufficient potential energy upon its deformation from its bent conformation to its more flattened conformation to revert automatically, without external energy input, to its initial bent conformation as soon as the bearing force has disappeared.

The plate 60 can have many different forms. For example, in a variant, the orthogonal projection of the plate on a vertical plane forms a portion of an ellipse whose focal axis is parallel to the axis 38 and whose eccentricity is, for example, less than 0.2 or 0.1. In another variant, the same plate comprises several convex bearing faces arranged one after the other along the axis 38. This embodiment can be obtained by mechanically coupling several copies of the plate 60 one after the other along the axis 38.

Other embodiments of the guiding mechanism are possible. For example, the guiding mechanism comprises one or more rails inside which the end 64 can slide only along the axis 38.

In another embodiment, it is the top face of the plate 54 which forms the bearing plane of the guiding mechanism. For that, for example, the hole 66 is completely or partly eliminated so that, in response to the bearing force, the bottom part of the flat 76 of the end 64 rests directly on the top face of the plate 54. In this case, it is this bottom part of the flat 76 which forms the abutment of the guiding mechanism. The flat 78 can then be omitted. It is also possible to replace the flats 76 and 78 with a single flat which extends vertically from the bearing face 68 to a bottom part slidingly bearing on the top face of the plate 54. It is then this vertical flat which forms the abutment of the guiding mechanism. In these last two embodiments, the bearing plane 74 is not formed by a wall of the casing of the sensor 80 but directly by the top face of the plate 54.

In other embodiments, the bearing plane 74 is formed on the end 64 and the abutment slidingly bearing on this bearing plane is formed on the rigid support 50.

Other sensor technologies can be used to detect the displacement of the end 64. For example, the sensitive face can use capacitive or magnetic technology to detect the proximity of the flat 76.

In a variant, the sensor is replaced by a sensor which measures the pressure exerted by the end 64 or which measures the displacement of this end. In this case, in addition to detecting the presence or the absence of a bearing force, the device also provides information on the amplitude of the bearing force or the speed of displacement of the load which provokes this bearing force.

In another embodiment, the sensor 80 is replaced by a sensor which measures the deformation of the plate. To this end, the deformation sensor is for exampled fixed directly on or under the face 68 of the plate 50 as described in the application WO99/41565A. The deformation sensor can also be produced as described in the applications DE102013213672A1 or WO0218892A2. In effect, the use of a plate of which one of the ends slides freely relative to the support always makes it possible to have a greater deformation of the plate than if the two ends of this plate were fixed with no degree of freedom to the support.

The sensor 80 does not have to be situated alongside the end 64. For example, a mechanism for transmitting the displacement of the end 64 can be interposed between this end and the sensor 80. Such a transmission mechanism comprises, for example, a cable or a rod which mechanically links the end 64 to the sensitive face 82 of the sensor 80. By virtue of such a transmission mechanism, the sensor 80 can be separated from the end 64 by as much as is desired.

The detection device can be used in many other applications. For example, it can be used to detect the crushing of a flexible material such as a flexible seal between two rigid frames. In this case, for example, the detection device is interposed between one of these rigid frames and the flexible seal. Consequently, when the flexible seal is crushed by the other frame, the flexible seal crushes the plate 60. This deformation of the plate 60 is then detected as described previously. For example, one of these frames is the upright of door and the other frame is the leaf of this same door. In this case, the detection device can be used to detect the opening and the closing of this door.

The detection device described here can also be used to detect the end of travel of an object made of hard material which is displaced. For example, this hard object can be a sliding door or a mechanical part.

The positioning in a rear quarter of the bottom rest described in the particular case of the device 34 can be implemented with any other type of device capable of detecting a bearing force exerted in a direction of indentation. In particular, it is not necessary for this device to be one of those previously described and for it to comprise a plate such as the plate 60.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A device capable of detecting a bearing force exerted in a direction of indentation, wherein the device comprises:
a support rigid by tension,
at least one plate which extends from a proximal end mounted on the support, to a free distal end, this plate being elastically deformable by the bearing force from:
a bent conformation in which the plate exhibits a convex bearing face on which the bearing force to be detected is directly exerted,
to a more flattened conformation in which the convex bearing face is more flattened,
a spring capable of permanently straining the plate to its bent conformation such that, after disappearance of the bearing force, the plate automatically reverts to its bent conformation,
a guiding mechanism also mounted on the support and capable, in response to the deformation of the plate, of guiding the free distal end of the plate in translation along a translation axis at right angles to the direction of indentation, and
a sensor capable of detecting a displacement of the free distal end along the translation axis to detect the bearing force, this sensor being fixed to the proximal end with no degree of freedom in translation along the translation axis.

2. The device according to claim 1, in which the plate and the spring are produced using one and the same plate spring.

3. The device according to claim 1, in which the sensor is mounted on the support alongside the plate in a direction at right angles to the direction of indentation.

4. The device according to claim 1, in which the ratio f/L is less than or equal to 0.5, where:
f is the amplitude of the deflection of the bearing face in its bent conformation, and
L is the length of the plate between its proximal and distal ends.

5. The device according to claim 1, in which the support extends primarily in a plane at right angles to the direction of indentation.

6. The device according to claim 1, in which the guiding mechanism comprises:
a bearing plane secured to one of the support and the plate, this bearing plane extending at right angles to the direction of indentation and along the translation axis of a length greater than or equal to the translational travel of the distal end between the bent and more flattened conformations of the plate, and
an abutment secured to the other of the support and the plate, this abutment slidingly bearing on the bearing plane.

7. The device according to claim 1, in which, in its bent conformation, the shortest distance between the proximal and distal ends is greater than 7 cm.

8. The device according to claim 1, in which the guiding mechanism allows the free distal end to be displaced in translation along the translation axis independently of the support.

9. A bottom rest of a seat, this bottom rest comprising:
a foam block,
an outer top face situated above the foam block and on which an occupant of the seat directly sits, and
a device capable of detecting a bearing force exerted on the top face of the bottom rest in a direction of indentation at right angles to the top face, wherein the device is capable of detecting the bearing force conforms to any one of the preceding claims.

10. The bottom rest according to claim 9, in which:
the bottom rest comprises a housing hollowed out inside the foam block and situated at least 1 cm below the top face and at least 1 cm above a bottom face of the foam block situated on the side opposite the top face, and
the device capable of detecting the bearing force is situated inside this housing.

11. A seat, characterized in that it comprises:
at least one bottom rest according to claim 9,
a back rest situated on the side of a rear edge of the bottom rest, and in which:
the top face of the bottom rest extends primarily along a plane called “bottom rest plane”,
the rectangle of smallest surface area which entirely contains the orthogonal projection of the top face in the bottom rest plane, comprises:
a rear side situated on the side of the rear edge of the bottom rest,
a front side situated on the side opposite the rear side, and
a first and a second lateral side each linking the front and rear sides, and
the orthogonal projections of the proximal and distal ends of the plate in the plane of the bottom rest are situated on an inclined axis which passes through points A and B of the bottom rest plane, the point A being situated at a distance less than or equal to 0.2 ddar from the intersection between the rear side and the first lateral side and the point B being situated at a distance less than or equal to 0.2 dar from the center of the rectangle, where the distance dar is the shortest distance which separates the two lateral sides.
